(19) United States
(12) Patent Application Publication
(10) Pub. No.: US 2026/0105898 A1
(43) Pub. Date: Apr. 16, 2026

(54) DISPLAY DEVICE AND METHOD FOR DRIVING DISPLAY DEVICE

(71) Applicant: LG ELECTRONICS INC., Seoul (KR)

(72) Inventors: Jeongjoo LEE, Seoul (KR); Minsik KIM, Seoul (KR); Jiwon PARK, Seoul (KR)

(73) Assignee: LG ELECTRONICS INC., Seoul (KR)

(21) Appl. No.: 19/116,639

(22) PCT Filed: Sep. 30, 2022
(86) PCT No.: PCT/KR2022/014763

§ 371 Date: Mar. 28, 2025

(51) Int. Cl. G09G 5/00; H04N 21/436; H04N 21/4363

(52) U.S. Cl. CPC G09G 5/006; H04N 21/43615; H04N 21/43635; G09G 2330/023; G09G 2370/12

(57) ABSTRACT

According to a display device and a method for driving same according to an embodiment of the present invention, when a control signal is received from an external device through an external device interface, whether or not to process the received control signal can be adaptively determined for the display device according to the content viewing environment of a user. A display device according to an embodiment of the present invention may comprise: an external device interface; a display for displaying content; and a controller which receives a power off request signal from an external device connected through an external device interface, and, if it is determined that the content being displayed on the display is not content provided from the external device, ignores and does not process the power off request signal received from the external device.

### TECHNICAL FIELD

The present disclosure relates to a display device and a method for driving the display device.

The present disclosure relates to a display device connected to an external equipment through an external device interface that provides an HDMI function and a method for driving the same.

The present disclosure relates to a display device connected to a plurality of external equipments through an external device interface that provides an HDMI function and a method for driving the same.

The present disclosure relates to a display device connected to an external device interface providing an HDMI function and a network interface accessed to a network, and a method for driving the same.

### BACKGROUND ART

The display device may display content provided from an external equipment (for example, a set-top box, a Blu-ray player, a DVD player, or the like) and may also display content provided through a content providing application of the display device (for example, liveTV, OTT (Over The Top), or the like).

Display devices and external equipments can be connected using HDMI (High Definition Multimedia Interface). HDMI is an uncompressed digital video/audio interface standard that provides an uncompressed, fully digital audio/video interface between HDMI-equipped audio/video devices such as set-top boxes, Blu-ray players, DVD players, and A/V receivers.

HDMI provides HDMI-CEC (Consumer Electronics Control) function. HDMI-CEC is a technology that allows you to control a plurality of equipments connected via HDMI simultaneously with a single remote control device. HDMI-CEC is a single-wire bidirectional serial bus based on the HDMI protocol.

When connecting a display device that supports HDMI-CEC and a set-top box or Blu-ray player, there is an advantage of be capable of being conveniently handling things like turning the power on and off, adjusting the volume, or changing channels simultaneously using a single remote control device.

When a plurality of external equipments are connected to the display device and the user does not want to use the CEC function, there is the inconvenience of having to disable the CEC function on each external equipment or turning off the CEC function altogether. In addition, the CEC function may operate unstably due to functional inconsistencies between product manufacturers or product types.

When an external equipment is connected to the display device via HDMI, using the HDMI-CEC function may allow the user to use the display device and the equipment more conveniently, but it may also cause errors, unintended operations by the user, or the display device or external equipment may stop operating.

### DISCLOSURE

### Technical Problem

The present disclosure provides a display device that can prevent an operation that is not intended by a user from occurring in a display device that the user is using due to a control signal input from an external equipment connected to the display device, and a method for driving the display device.

The present disclosure provides a display device that can process a signal of a power-on and input switching request input from an external equipment without loss in the display device when a user requests power-on of an external equipment connected to the display device while the display device is turned off and, and a method for driving the display device.

The present disclosure provides a display device that can quickly transmit a control signal or data from the display device to an external equipment connected to the display device via a network and HDMI, and a method for driving the display device.

### Technical Solution

According to a display device and a method for driving the same according to an embodiment of the present disclosure, when a control signal is received from an external equipment through an external device interface, whether or not to process the received control signal for the display device can be adaptively performed according to the user's content viewing environment.

A display device according to an embodiment of the present disclosure may include an external device interface; a display that displays content; a controller that receives a power-off request signal from an external equipment connected through the external device interface, and, if determining that the content displayed on the display is not content provided by the external equipment, ignores and does not process the power-off request signal received from the external equipment.

According to a display device according to an embodiment of the present disclosure, the controller may process power off of the display device in response to the power off request signal received from the external equipment when determining that the content displayed on the display is content provided from the external equipment.

According to a display device according to an embodiment of the present disclosure, the external device interface and the external equipment may be connected using a HDMI protocol, and the power off request signal may be transmitted by the HDMI-CEC (Consumer Electronics Control) power sync function of the external equipment.

According to a display device according to an embodiment of the present disclosure, the external equipment connected through the external device interface may include a first external equipment and a second external equipment, and when the content provided from the first external device is displayed on the display, if the power-off request signal is received from the second external equipment, the controller may ignore and may not process the power-off request signal.

According to a display device according to an embodiment of the present disclosure, when the content provided from the first external equipment is displayed on the display, if the power-off request signal is received from the first external equipment, the controller may process the power-off of the display device in response to the power-off request signal.

According to a display device according to an embodiment of the present disclosure, the content displayed on the display may be driven as a foreground on the display.

According to a display device according to an embodiment of the present disclosure, if the content displayed on the display is displayed by a content providing application provided by the display device, the controller may ignore and may not process the power off request signal.

According to a display device according to an embodiment of the present disclosure, the controller may determine whether to process the received control signal from the external equipment connected through the external device interface and filter and process the received control signal according to the manufacturer of the external equipment or the type of the external equipment.

According to a display device according to an embodiment of the present disclosure may further include a memory that stores an input switching request signal received from the external equipment connected through the external device interface, in which the controller, when the display device is turned off, if a power-on request signal and the input switching request signal are received from the external equipment, may process initialization of the display device in response to the power-on request signal, and when the initialization of the display device is completed, may process input switching to the external equipment corresponding to the input switching request signal stored in the memory.

According to a display device according to an embodiment of the present disclosure may further include a network interface accessed to a network, in which the controller may transmit a control signal or data to be transmitted to the external equipment through the network interface, if the external equipment connected through the external device interface is also connected through the network interface.

A method for driving a display device according to an embodiment of the present disclosure may include receiving a power-off request signal from an external equipment connected through an external device interface; determining whether the content displayed on the display is content provided by the external equipment; and ignoring and not processing the power-off request signal received from the external equipment if the controller determines that the content displayed on the display is not content provided by the external equipment.

According to a method for driving a display device according to an embodiment of the present disclosure, the controller may process power off of the display device in response to the power off request signal received from the external equipment when determining that the content displayed on the display is content provided from the external equipment.

According to a method for driving a display device according to an embodiment of the present disclosure, the external device interface and the external equipment may be connected using a HDMI protocol, and the power off request signal may be transmitted by the HDMI-CEC (Consumer Electronics Control) power sync function of the external equipment.

According to a method for driving a display device according to an embodiment of the present disclosure, when content provided from a first external equipment connected through the external device interface is displayed on the display, if the power off request signal is received from the second external equipment connected through the external device interface, the controller may ignore and may not process the power off request signal.

According to a method for driving a display device according to an embodiment of the present disclosure, when the content provided from the first external equipment is displayed on the display, if the power-off request signal is received from the first external equipment, the controller may process the power-off of the display device in response to the power-off request signal.

According to a method for driving a display device according to an embodiment of the present disclosure, the content displayed on the display may be driven as a foreground on the display.

According to a method for driving a display device according to an embodiment of the present disclosure, if the content displayed on the display is displayed by a content providing application provided by the display device, the controller may ignore and may not process the power off request signal.

According to a method for driving a display device according to an embodiment of the present disclosure, the controller may determine whether to process the received control signal from the external equipment connected through the external device interface and filter and process the received control signal according to the manufacturer of the external equipment or the type of the external equipment.

According to a method for driving a display device according to an embodiment of the present disclosure, when the display device is turned off, if a power-on request signal and an input switching request signal are received from the external equipment, the controller may store the input switching request signal in memory while processing the initialization of the display device in response to the power-on request signal, and when the initialization of the display device is completed, the controller may process the input switching to the external equipment corresponding to the input switching request signal stored in the memory.

According to a method for driving a display device according to an embodiment of the present disclosure, if the external equipment connected through the external device interface is also connected through a network interface that is accessed to a network, the controller may transmit a control signal or data to be transmitted to the external equipment through the network interface.

### Advantageous Effect

According to the display device and the method for driving the display device according to the embodiment of the present disclosure, it is possible to prevent an operation that is not intended by a user from occurring in the display device being used by the user due to a control signal input from an external equipment connected to the display device.

According to a display device and a method for driving a display device according to an embodiment of the present disclosure, when a user requests to turn on a power of an external equipment connected to the display device while the display device is turned off, a signal of a power-on and input switching request input from the external equipment can be processed without being lost in the display device.

According to the display device and the driving method of the display device according to the embodiment of the present disclosure, a control signal or data can be quickly transmitted from the display device to an external equipment connected to the display device via a network and HDMI.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device according to an embodiment of the present disclosure.

FIG. 4 is a view illustrating an example of utilizing the remote control device according to an embodiment of the present disclosure.

FIG. 5 is a block diagram illustrating a display device according to an embodiment of the present disclosure.

FIG. 6 is a diagram illustrating a method for driving a display device according to an embodiment of the present disclosure.

FIG. 7 is a diagram illustrating an input/output configuration of HDMI according to an embodiment of the present disclosure.

FIG. 8 is a diagram illustrating a method for driving a display device according to an embodiment of the present disclosure.

FIG. 9 is a block diagram illustrating a display device according to an embodiment of the present disclosure.

FIG. 10 is a diagram illustrating a method for driving a display device according to an embodiment of the present disclosure.

FIG. 11 is a block diagram illustrating a display device according to an embodiment of the present disclosure.

FIG. 12 is a diagram illustrating a method for driving a display device according to an embodiment of the present disclosure.

### BEST MODE

Hereinafter, embodiments relating to the present disclosure will be described in detail with reference to the accompanying drawings. The suffixes “interface”, “module” and “unit” for components used in the description below are assigned or mixed in consideration of easiness in writing the specification and do not have distinctive meanings or roles by themselves.

A display device according to an embodiment of the present disclosure, for example, as an artificial display device that adds a computer supporting function to a broadcast receiving function, can have an easy-to-use interface such as a writing input device, a touch screen, or a spatial remote control device as an Internet function is added while fulfilling the broadcast receiving function. Then, with the support of a wired or wireless Internet function, it is possible to perform an e-mail, web browsing, banking, or game function in access to Internet and computers. In order to perform such various functions, standardized general purpose OS can be used.

Accordingly, since various applications are freely added or deleted on a general purpose OS kernel, a display device described herein, for example, can perform various user-friendly functions. The display device, in more detail, can be a network TV, Hybrid Broadcast Broadband TV (HBBTV), smart TV, light-emitting diode (LED) TV, organic light-emitting diode (OLED) TV, and so on and in some cases, can be applied to a smartphone.

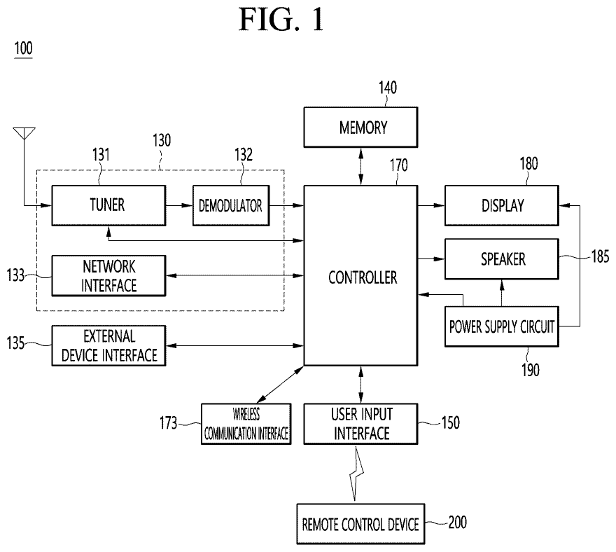

FIG. 1 is a block diagram illustrating a configuration of a display device according to an embodiment of the present disclosure.

Referring to FIG. 1, a display device 100 may include a broadcast reception module 130, an external device interface unit 135, a storage unit 140, a user input unit 150, a control unit 170, a wireless communication interface unit 173, a display unit 180, an audio output unit 185, and a power supply unit 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program-related data signals, and may restore the divided video signals, audio signals, and data signals into an output available form.

The external device interface unit 135 may receive an application or an application list in an adjacent external equipment and deliver the application or the application list to the control unit 170 or the storage unit 140.

The external device interface unit 135 may provide a connection path between the display device 100 and an external equipment. The external device interface unit 135 may receive at least one of an image or audio outputted from an external equipment that is wirelessly or wiredly connected to the display device 100 and deliver the received image or the audio to the controller. The external device interface unit 135 may include a plurality of external input terminals. The plurality of external input terminals may include an RGB terminal, at least one High Definition Multimedia Interface (HDMI) terminal, and a component terminal.

An image signal of an external equipment inputted through the external device interface unit 135 may be outputted through the display unit 180. A sound signal of an external equipment inputted through the external device interface unit 135 may be outputted through the audio output unit 185.

An external equipment connectable to the external device interface unit 135 may be one of a set-top box, a Blu-ray player, a DVD player, a game console, a sound bar, a smartphone, a PC, a USB Memory, and a home theater system but this is just exemplary.

The network interface 133 may provide an interface for connecting the display device 100 to a wired/wireless network comprising internet network. The network interface 133 may transmit or receive data to or from another user or another electronic device through an accessed network or another network linked to the accessed network.

Additionally, some content data stored in the display device 100 may be transmitted to a user or an electronic device, which is selected from other users or other electronic devices pre-registered in the display device 100.

The network interface unit 133 may access a predetermined webpage through an accessed network or another network linked to the accessed network. That is, the network interface unit 133 may transmit or receive data to or from a corresponding server by accessing a predetermined webpage through the network.

The network interface unit 133 may receive content or data provided from a content provider or a network operator. That is, the network interface unit 133 may receive content, such as movies, advertisements, games, VODs, and broadcast signals, which are provided from the content provider or the network operator, and information relating thereto through the network.

In addition, the network interface unit 133 may receive firmware update information and update files provided from the network operator, and may transmit data to the Internet or content provider or the network operator.

The network interface 133 may select and receive a desired application among applications open to the air, through network.

The storage unit 140 may store signal-processed image, voice, or data signals stored by a program in order for each signal processing and control in the control unit 170.

In addition, the storage unit 140 may perform a function for temporarily storing image, voice, or data signals output from the external device interface unit 135 or the network interface unit 133, and may store information on a predetermined image through a channel memory function.

The storage unit 140 may store an application or an application list input from the external device interface unit 135 or the network interface unit 133.

The display device 100 may play content files (for example, video files, still image files, music files, document files, application files, etc.) stored in the storage unit 140, and may provide the content files to a user.

The user input unit 150 may transmit signals input by a user to the control unit 170, or may transmit signals from the control unit 170 to a user. For example, the user input unit 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR communication methods.

In addition, the user input unit 150 may transmit, to the control unit 170, control signals input from local keys (not shown) such as a power key, a channel key, a volume key, and a setting key.

Image signals that are image-processed by the control unit 170 may be input to the display unit 180 and displayed as images corresponding to the image signals. In addition, image signals that are image-processed by the control unit 170 may be input to an external output device through the external device interface unit 135.

Voice signals processed by the control unit 170 may be output to the audio output unit 185. In addition, voice signals processed by the control unit 170 may be input to the external output device through the external device interface unit 135.

Additionally, the control unit 170 may control overall operations of the display device 100.

In addition, the control unit 170 may control the display device 100 by a user command or an internal program input through the user input unit 150, and may access the network to download a desired application or application list into the display device 100.

The control unit 170 may output channel information selected by a user together with the processed image or voice signals through the display unit 180 or the audio output unit 185.

In addition, the control unit 170 may output image signals or voice signals of an external equipment such as a camera or a camcorder, which are input through the external device interface unit 135, through the display unit 180 or the audio output unit 185, according to an external equipment image playback command received through the user input unit 150.

Moreover, the control unit 170 may control the display unit 180 to display images, and may control the display unit 180 to display broadcast images input through the tuner 131, external input images input through the external device interface unit 135, images input through the network interface unit, or images stored in the storage unit 140. In this case, an image displayed on the display unit 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

Moreover, the wireless communication unit 173 may perform wired or wireless communication with an external equipment. The wireless communication unit 173 may perform short-range communication with an external equipment. For this, the wireless communication unit 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication unit 173 may detect (or recognize) a wearable device capable of communication around the display device 100.

Furthermore, if the detected wearable device is a device authenticated to communicate with the display device 100, the control unit 170 may transmit at least part of data processed in the display device 100 to the wearable device through the wireless communication unit 173. Therefore, a user of the wearable device may use the data processed by the display device 100 through the wearable device.

The display unit 180 may convert image signals, data signals, or on-screen display (OSD) signals, which are processed in the control unit 170, or images signals or data signals, which are received in the external device interface unit 135, into R, G, and B signals to generate driving signals.

Furthermore, the display device 100 shown in FIG. 1 is just one embodiment of the present disclosure and thus, some of the components shown may be integrated, added, or omitted according to the specification of the actually implemented display device 100.

That is, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display unit 180 and the audio output unit 185.

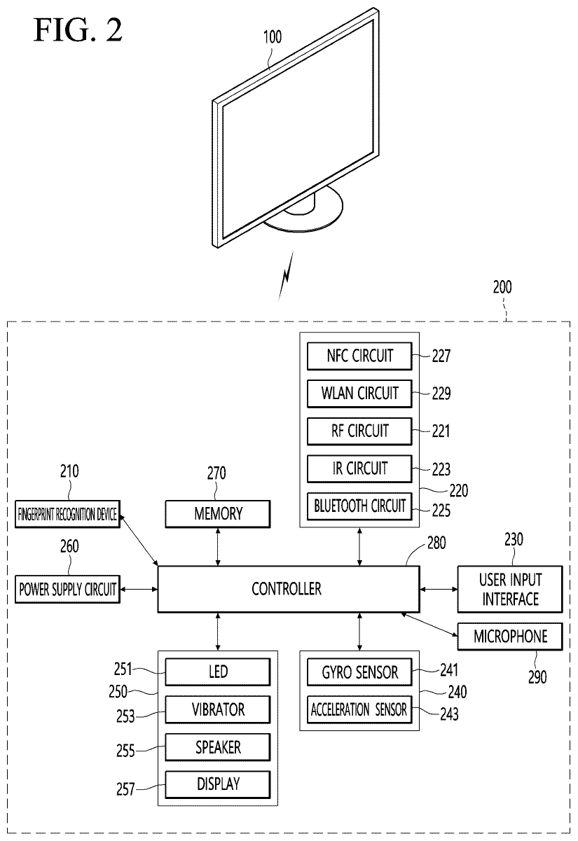

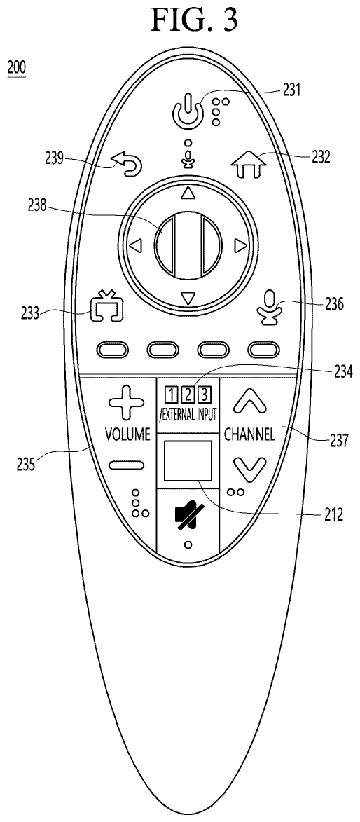

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition unit 210, a wireless communication unit 220, a user input unit 230, a sensor unit 240, an output unit 250, a power supply unit 260, a storage unit 270, a control unit 280, and a sound acquisition unit 290.

Referring to FIG. 2, the wireless communication unit 220 transmits/receives signals to/from an arbitrary any one of display devices according to the above-mentioned embodiments of the present disclosure.

The remote control device 200 may include a radio frequency (RF) module 221 capable of transmitting or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication unit 220.

Moreover, the remote control device 200 may receive signals transmitted from the display device 100 through the RF module 221 and if necessary, may transmit a command for power on/off, channel change, and volume change to the display device 100 through the IR module 223.

The user input unit 230 may be configured with a keypad, a button, a touch pad, or a touch screen. A user may operate the user input unit 230 to input a command relating to the display device 100 to the remote control device 200. If the user input unit 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume adjustment button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation.

The power button 231 may be a button for turning on/off the power of the display device 100.

The home button 232 may be a button for moving to the home screen of the display device 100.

The live button 233 may be a button for displaying live broadcast programs.

The external input button 234 may be a button for receiving an external input connected to the display device 100.

The volume adjustment button 235 may be a button for controlling a volume output from the display device 100.

The voice recognition button 236 may be a button for receiving user's voice and recognizing the received voice.

The channel change button 237 may be a button for receiving broadcast signals of a specific broadcast channel.

The OK button 238 may be a button for selecting a specific function, and the back button 239 may be a button for returning to a previous screen.

FIG. 2 is described again.

If the user input unit 230 includes a touch screen, a user may touch a soft key of the touch screen to input a command relating to the display device 100 to the remote control device 200. In addition, the user input unit 230 may include various kinds of input interfaces operable by a user, for example, a scroll key and a jog key, and this embodiment does not limit the scope of the present disclosure.

The sensor unit 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display unit 180 of the display device 100.

The output unit 250 may output image or voice signals in response to the operation of the user input unit 230, or may output image or voice signals corresponding to signals transmitted from the display device 100.

A user may recognize whether the user input unit 230 is operated or the display device 100 is controlled through the output unit 250.

For example, the output unit 250 may include an LED module 251 for flashing, a vibration module 253 for generating vibration, a sound output module 255 for outputting sound, or a display module 257 for outputting an image, if the user input unit 230 is manipulated or signals are transmitted/received to/from the display device 100 through the wireless communication unit 220.

Additionally, the power supply unit 260 supplies power to the remote control device 200 and if the remote control device 200 does not move for a predetermined time, stops the power supply, so that power waste may be reduced.

The power supply unit 260 may resume the supply of power if a predetermined key provided at the remote control device 200 is operated.

The storage unit 270 may store various kinds of programs and application data required to control or operate the remote control device 200.

If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to the control of the remote control device 200. The control unit 280 may transmit a signal corresponding to a predetermined key operation of the user input unit 230 or a signal corresponding to the movement of the remote control device 200 sensed by the sensor unit 240 to the display device 100 through the wireless communication unit 220.

In addition, the sound acquisition unit 290 of the remote control device 200 may acquire voice.

The sound acquisition unit 290 may include at least one microphone and acquire voice through the microphone.

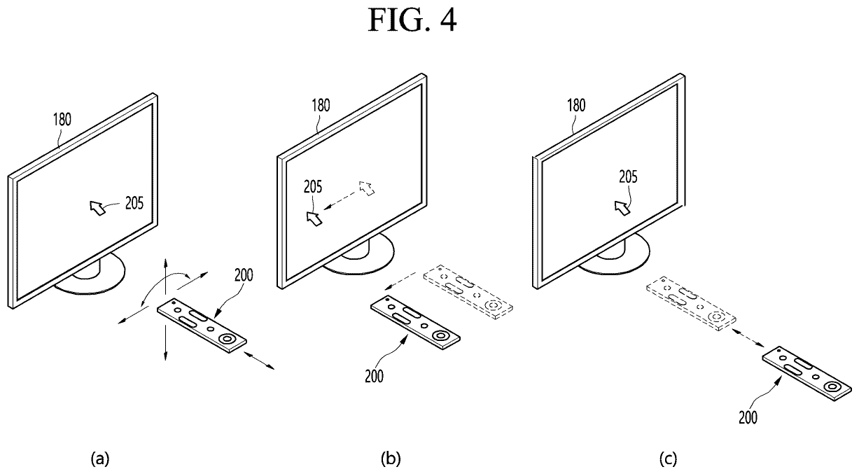

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display unit 180.

A user may move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as show in the drawing, the remote control device 200 may be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display unit 180. Thus, a selected region in the display unit 180 corresponding to the pointer 205 may be zoomed in and displayed in an enlarged size.

On the other hand, if a user moves the remote control device 200 close to the display unit 180, a selection area in the display unit 180 corresponding to the pointer 205 may be zoomed out and displayed in a reduced size.

On the other hand, if the remote control device 200 is moved away from the display unit 180, a selection area may be zoomed out and if the remote control device 200 is moved closer to the display unit 180, a selection area may be zoomed in.

Additionally, if a specific button in the remote control device 200 is pressed, recognition of a vertical or horizontal movement may be excluded. That is, if the remote control device 200 is moved away from or closer to the display unit 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display unit 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display unit 180 and also may be displayed in correspondence to a plurality of points such as a line and a surface.

Various embodiments will be further described with reference to the attached drawings for the display device 100 and a method for driving the same described above.

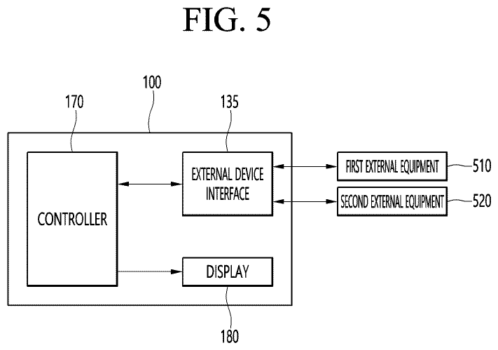

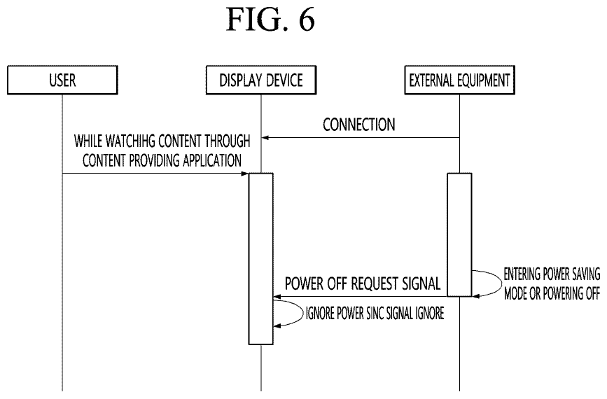

First, with reference to FIGS. 5 and 6, the operation of the display device 100 connected to an external equipment through an external device interface 135 will be examined.

FIG. 5 is a block diagram illustrating a display device according to an embodiment of the present disclosure, and FIG. 6 is a diagram illustrating a method for driving a display device according to an embodiment of the present disclosure.

The display device 100 according to the embodiment may include an external device interface 135, a controller 170, and a display 180, as illustrated in FIG. 5.

The display device 100 can be connected to an external equipment through an external device interface 135. The display device 100 can be connected to a plurality of external equipments. For example, the display device 100 and the external equipment can be connected using an HDMI (High Definition Multimedia Interface) protocol.

FIG. 5 illustrates a case where a display device 100 is connected to a first external equipment 510 and a second external equipment 520 via an external device interface 135. However, the display device 100 may not be connected to an external equipment, may be connected to one external equipment, or may be connected to three or more external equipments.

External equipments can be independently selected from equipments including set-top boxes (STBs), Blu-ray players, DVD players, game consoles, sound bars, and the like.

The external device interface 135 can provide a connection path between the display device 100 and the external equipment. The external device interface 135 can receive content output from the external equipment to the display device 100 and transmit the content to the controller 170. The content can include one or more of image and audio.

For example, the first external equipment 510 connected to the external device interface 135 may be a set-top box, and the second external equipment 520 connected via the external device interface 135 may be a Blu-ray player.

The controller 170 can display the received content on the display 180. The controller 170 can display the content received through a first external equipment 510, for example, a set-top box, on the display 180. In addition, the controller 170 can display the content received through a second external equipment 520, for example, a Blu-ray player, on the display 180.

The controller 170 can receive a control request signal for the display device 100 from the first external equipment 510 or the second external equipment 520 through the external device interface 135. The control request signal can include a power off request signal, a power on request signal, a volume adjustment request signal, a channel change request signal, or the like.

When using the display device 100, the user may select the “TV” mode or the “external input”mode in the input signal setting mode of “TV/external input,” for example.

When the input signal setting of the display device 100 is selected as “external input” mode, the user can select an external equipment to receive content from among the external equipments connected through the external device interface 135.

For example, when a user selects a set-top box, which is a first external equipment 510, in the “external input” mode, the display device 100 can receive content from the set-top box, which is the first external equipment 510, and display the content on the display 180.

When a user selects a Blu-ray player, which is a second external equipment 520, in the “external input” mode, the display device 100 can receive content from the Blu-ray player, which is a second external equipment 520, and display the content on the display 180.

When the input signal setting of the display device 100 is selected as “TV” mode, the user can select a “TV channel” or “content providing application” provided by the display device 100. The content providing application may include liveTV, OTT (Over The Top), or the like.

A user may select the Netflix app as an example of OTT. When the user selects the Netflix app, content provided by the Netflix app may be displayed on the display 180.

As described above, the display device 100 may display content provided from an external equipment, according to the input signal setting mode, or may display content through a content providing application provided by the display device 100, regardless of connection to the external equipment.

Meanwhile, as illustrated in FIG. 6, in a state where an external equipment, for example, a set-top box, is connected to the display device 100, the user may display content provided through a content providing application of the display device 100, for example, a Netflix app, on the display 180.

In this environment, if a user uses content provided through a Netflix-provided app for a long period of time, the set-top box, which is the first external equipment 510 connected through the external device interface 135, remains unused for that period of time.

The set-top box may provide a function to automatically switch to standby mode or automatically turn off the power if the set-top box is not used by the user for a certain period of time. When the set-top box performs the function of automatically turning off the power, the set-top box may transmit a power-off request signal to the display device 100.

A first external equipment 510, for example, a set-top box, may transmit a power off request signal to the display device 100 through the external device interface 135. The power off request signal may be transmitted by the HDMI-CEC (Consumer Electronics Control) power sync function.

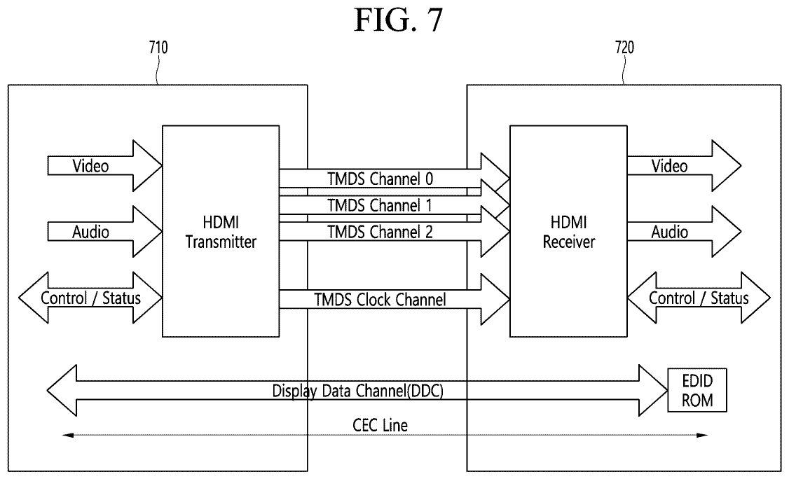

FIG. 7 is a diagram illustrating an input/output configuration of HDMI according to an embodiment of the present disclosure.

HDMI is an interface that transmits digital image signals and digital audio signals, which were transmitted separately via DVI and S/PDIF, without compression via a single cable. HDMI can include three TMDS (Transition Minimized Differential Signaling) data channels (0, 1, 2), a TMDS clock channel, a DDC channel, a CEC line, and power (+5V).

At this time, digital image signals, that is, each image signal component of RGB, YCbCr, and voice signals are synthesized in the form of a single packet on three TMDS data channels 0, 1, 2. In addition, power (+5V) is configured so that an external equipment can read the EDID (Extended Display Identification Data) information of the display device through the DDC (Display Data Channel) even when the display device is turned off.

In order to enable signal synthesis and transmission in the HDMI manner, the external equipment 710 includes an HDMI transmitter for synthesizing and transmitting digital image signals and digital voice signals in packet form, and the display device 720 includes an HDMI receiver for receiving the packets and separating the digital image signals and digital voice signals.

In the case of conventional display devices, when a power-off request signal by the HDMI-CEC power sync function is received from a set-top box connected to an external device interface, the display device powers off in response to the received power-off request signal.

This is an action against the will of the user viewing the content, and causes the display device to automatically turn off in response to the received power-off request signal, resulting in user inconvenience.

Accordingly, according to the display device 100 and the method for driving the same according to the embodiment of the present disclosure, when a power-off request signal is received from an external equipment through an external device interface 135, a method is presented for adaptively performing processing on whether to turn off the display device 100 according to the user's content viewing environment.

When a power-off request signal is received from an external equipment, such as a set-top box, connected via an external device interface 135, the controller 170 of the display device 100 according to the embodiment determines whether the content displayed on the display 180 is content provided from an external equipment, such as a set-top box.

The content displayed on the display 180 may mean content that is driven and displayed as a foreground on the display 180.

An external device interface 135 and an external equipment, for example, a set-top box, are connected using an HDMI protocol, and a power-off request signal can be transmitted by an HDMI-CEC (Consumer Electronics Control) power sync function of an external equipment, for example, a set-top box. In addition, the power-off request signal input from the set-top box can be a signal transmitted by operating a power-off button of a remote control device of the set-top box.

If the controller 170 determines that the content displayed on the display 180 is not content provided from an external equipment, such as a set-top box, it may ignore and not process a power-off request signal received from the set-top box.

The display device 100 can continue to display content currently displayed on the display 180 without interruption, without performing processing corresponding to a power-off request signal received from an external equipment, such as a set-top box. Accordingly, a user can continue to view content displayed on the display 180.

For example, if the content being displayed on the display 180 is displayed by a content providing application provided by the display device 100, the controller 170 may ignore and not process the received power off request signal. The controller 170 may continue to display the content being provided by the content providing application on the display 180.

If the controller 170 determines that the content displayed on the display 180 is content provided from an external equipment, such as a set-top box, the controller 170 can process power-off of the display device 100 in response to a power-off request signal received from the external equipment, such as a set-top box.

Meanwhile, as another method, when a power off request signal is received from an external equipment, such as a set-top box, connected via an external device interface 135, the controller 170 of the display device 100 according to the embodiment can check the input signal setting mode of “TV/external input” of the display device 100 and adaptively determine whether to process the received power off request signal according to the input signal setting mode of the display device 100.

The controller 170 may ignore and not process a power off request signal received from an external equipment, such as a set-top box, if the input signal setting mode of the display device 100 is selected as “TV” mode.

The display device 100 can continue to display content currently displayed on the display 180 without interruption, without performing processing corresponding to a power-off request signal received from an external equipment, such as a set-top box. Accordingly, a user can continue to view content displayed on the display 180.

For example, if the content being displayed on the display 180 is displayed by a content providing application provided by the display device 100, the controller 170 may ignore and not process the received power off request signal. The controller 170 may continue to display the content being provided by the content providing application on the display 180.

If the controller 170 determines that the input signal setting mode of the display device 100 is selected as the “external input” mode and that the content displayed on the display 180 is content provided from an external equipment, such as a set-top box, the controller 170 can process power-off of the display device 100 in response to a power-off request signal received from an external equipment, such as a set-top box.

Meanwhile, as described with reference to FIG. 5, an external equipment connected via an external device interface 135 may include a plurality of external equipments, for example, a first external equipment 510 and a second external equipment 520.

Regarding the display device and the method for driving the same according to an embodiment of the present disclosure, a case where a first external equipment (for example, a set-top box) 510 and a second external equipment (for example, a Blu-ray player) 520 are connected to an external device interface 135 will be further examined.

When content provided from a first external equipment 510 connected through an external device interface 135 is being displayed on the display 180, if a power-off request signal is received from a second external equipment 520 connected through the external device interface 135, the controller 170 may ignore and not process the received power-off request signal.

For example, when content provided through a set-top box is being displayed on the display 180, if a power-off request signal is received from the Blu-ray player, the controller 170 may not perform processing corresponding to the received power-off request signal and may continue to display the content provided through the set-top box on the display 180.

Accordingly, it is possible to prevent the power of the device currently in use from being automatically turned off unintentionally due to a control signal input from another external equipment.

When content provided from a first external equipment 510 is being displayed on the display 180, the controller 170 can process power-off of the display device 100 in response to a power-off request signal when a power-off request signal is received from the first external equipment 510.

For example, when content provided through a set-top box is displayed on a display 180, if a power-off request signal is received from the set-top box, the controller 170 can process power-off of the display device 100 in response to the received power-off request signal.

According to a display device and a method for driving the same according to an embodiment, when a power-off request signal is received from an external equipment through an external device interface, there is an advantage in that power-off of the display device can be adaptively performed according to a user's content viewing environment.

According to a display device and a method for driving the same according to an embodiment, when a power-off request signal is received from an external equipment through an external device interface, there is an advantage in that the phenomenon of the display device being turned off against the user's intention to use the display device can be prevented.

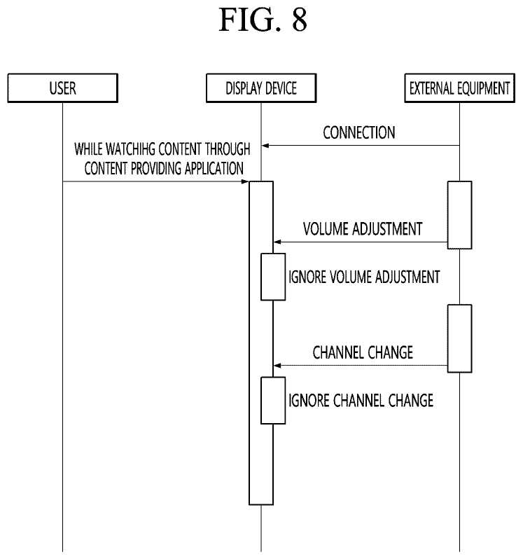

Next, with reference to FIGS. 5 and 8, a display device and a method for driving the same that can prevent a user from recognizing that a malfunction of the display device 100 has occurred due to volume adjustment or channel change of the display device 100 being operated by a key operation input from an unauthorized external equipment will be examined in more detail.

FIG. 8 is a diagram illustrating a method for driving a display device according to an embodiment of the present disclosure.

The display device 100 processes a control request received via an HDMI-CEC packet from an external equipment connected via an external device interface 135.

For example, when a request for volume adjustment or channel change is received from an external equipment, such as a set-top box, connected via an external device interface 135, the controller 170 may perform volume adjustment or channel change of the display device 100 in response to the received control request.

However, for display devices 100 and external equipments that employ HDMI, functional compatibility with the display device 100 may differ according to the manufacturer of the external equipment or the type of the external equipment. If functional compatibility is not secured between devices that employ HDMI, a malfunction unintended by the user may occur in the display device 100 due to key operations input from an external equipment connected to the external device interface 135.

Accordingly, according to the display device and the method for driving the same according to the embodiment, a function of filtering and processing key operations requested from an external equipment according to the manufacturer and type of the external equipment can be provided.

The controller 170 can determine whether to process the control signal received according to the manufacturer of the external equipment 510, 520 or the type of the external equipment 510, 520 and filter and process the control signal received from the external equipment 510, 520 connected through an external device interface 135.

For example, the controller 170 may process volume adjustment or channel change of the display device 100 in response to a control signal for volume adjustment or channel change input from an authorized external equipment such as a set-top box.

However, if a control signal such as volume adjustment or channel change is received from an unauthorized external equipment, the controller 170 may ignore and not process the received control signal such as volume adjustment or channel change.

According to the display device and the method for driving the same according to the embodiment, through an authorization process for the manufacturer of the external equipment or the type of the external equipment, the controller 170 can provide a filtering function that can perform a corresponding operation in response to a control request for the display device 100 received from the external equipment or ignore the control request.

According to the display device and the method for driving the same according to the embodiment, it is possible to prevent volume adjustment or channel change of the display device 100 from being processed by a key operation input from an unauthorized external equipment.

According to the display device and the method for driving the same according to the embodiment, it is possible to prevent malfunction of the display device 100 due to a key operation input from an unauthorized external equipment.

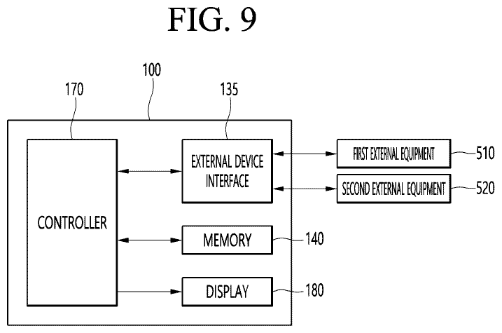

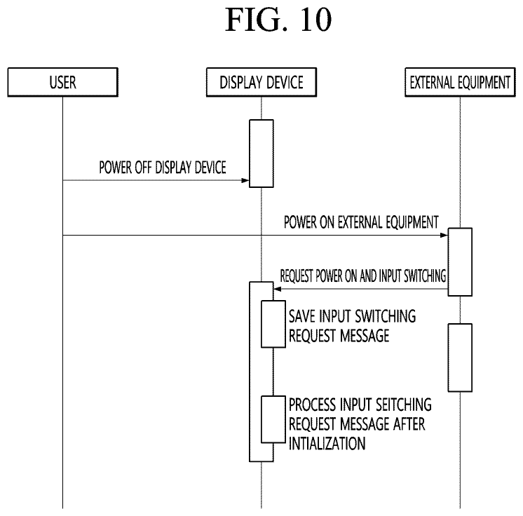

Next, with reference to FIGS. 9 and 10, the operation of the display device 100 will be examined when a user turns on the power of an external equipment connected to the display device 100 through an external device interface 135 in a state where the display device 100 is turned off.

FIG. 9 is a block diagram illustrating a display device according to an embodiment of the present disclosure, and FIG. 10 is a diagram illustrating a method for driving a display device according to an embodiment of the present disclosure.

A display device 100 according to an embodiment may include a controller 170, an external device interface 135, a memory 140, and a display 180.

A plurality of external equipments, for example, a first external equipment 510, for example, a set-top box, and a second external equipment 520, for example, a Blu-ray player, can be connected to the display device 100 via the external device interface 135.

According to an embodiment, as illustrated in FIG. 10, a user can turn on the power of an external equipment, such as a set-top box, in a state where the display device 100 is turned off.

When a user transmits a power-on control signal to the set-top box using the remote adjustment device of the set-top box, while the power of the external equipment (for example, the set-top box) is turned on, the external equipment (for example, the set-top box) transmits a power-on and input switching request message to the display device 100 by the HDMI-CEC function.

The controller 170 of the display device 100 first turns on the power of the display device 100 and performs initialization to perform processing in response to a power-on and input switching request received from an external equipment (for example, a set-top box).

Thereafter, the controller 170 performs processing to respond to an input switching request received from an external equipment (for example, a set-top box) after the initialization of the display device 100 is completed. For example, the display device 100 may provide a connection state in which content, a control signal, or the like may be input from an external equipment (for example, a set-top box) or may display a screen to which an external equipment (for example, a set-top box) is connected on the display 180.

However, if the initialization time of the display device 100 takes a long time, a situation may occur in which an input switching request message transmitted from an external equipment (for example, a set-top box) to the display device 100 is partially lost or not completely transmitted before the initialization of the display device 100 is completed.

In this way, if a situation occurs in which an input switching request message transmitted from an external equipment (for example, a set-top box) to the display device 100 is partially lost or not completely transmitted, the display device 100 cannot provide a state for responding to the input switching request transmitted from the external equipment (for example, a set-top box).

For example, the controller 170 of the display device 100 may turn on the display device 100 in response to a received power-on request signal and perform initialization, and then display the screen of the display device 100 in its last state just before it was turned off on the display 180.

Accordingly, the operation status of the display device 100 and external equipment (for example, set-top box) intended by the user is not implemented normally, causing inconvenience to the user.

According to the display and the method for driving the same according to the embodiment of the present disclosure, as one way to resolve user inconvenience, an input switching request message is processed using the memory 140 of the display device 100.

The controller 170 of the display device 100 may include a memory 140 that stores an input switching request signal received from an external equipment (for example, a set-top box) connected through an external device interface 135.

When the controller 170 receives a power-on request signal and an input switching request signal from an external equipment (for example, a set-top box) while the display device 100 is turned off, the controller 170 turns on the power of the display device 100 and processes initialization in response to the power-on request signal. Then, when the initialization of the display device 100 is completed, the controller 170 processes input switching to an external equipment (for example, a set-top box) corresponding to the input switching request signal stored in the memory 140.

Accordingly, even if the initialization time of the display device 100 takes a long time, it is possible to prevent a situation in which an input switching request message transmitted from an external equipment (for example, a set-top box) to the display device 100 is partially lost or not completely transmitted before the initialization of the display device 100 is completed.

A display device 100 according to an embodiment may provide a connection state capable of receiving content or control signals from an external equipment (for example, a set-top box) or display a screen to which an external equipment (for example, a set-top box) is connected on the display 180.

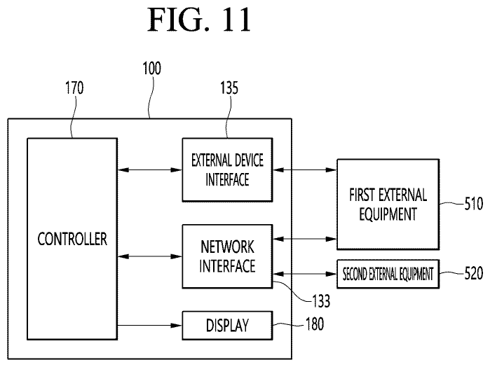

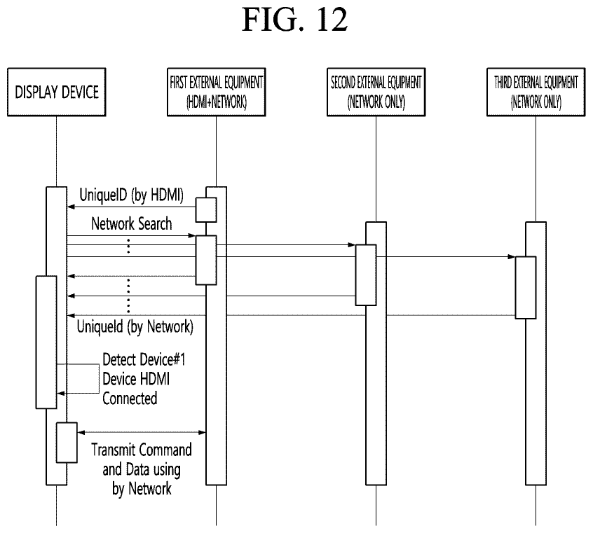

Next, with reference to FIGS. 11 and 12, the operation of the display device 100 will be examined when an external equipment is connected to the display device 100 through both an external device interface 135 and a network interface 133.

FIG. 11 is a block diagram illustrating a display device according to an embodiment of the present disclosure, and FIG. 12 is a diagram illustrating a method for driving a display device according to an embodiment of the present disclosure.

A display device 100 according to an embodiment may include a controller 170, an external device interface 135 connected to an external equipment, a network interface 133 connected to a network, and a display 180 that displays content, as illustrated in FIG. 11.

The network interface 133 can provide an interface for connecting the display device 100 to a wired/wireless network including the Internet. The network interface 133 can transmit or receive data to or from another user or another electronic device through the accessed network or another network linked to the connected network.

The display device 100 can be connected to an external equipment through an external device interface 135. Additionally, the display device 100 can be connected to an external equipment through a network interface 133.

An external equipment connected to the display device 100 can be connected to the display device 100 through at least one of an external device interface 135 and a network interface 133.

For example, a first external equipment 510 may be connected to the display device 100 via both an external device interface 135 and a network interface 133. A second external equipment 520 may be connected to the display device 100 via the network interface 133.

The controller 170 of the display device 100 can detect an external equipment (for example, a first external equipment 510) connected through an external device interface 135. The controller 170 can detect an external equipment (for example, a first external equipment 510 and a second external equipment 520) connected through a network interface 133.

The controller 170 can transmit a control signal or data to the first external equipment 510 through the external device interface 135. For example, the controller 170 can transmit a control signal or data to the first external equipment 510 through HDMI-CEC.

Additionally, the controller 170 can transmit a control signal or data to the first external equipment 510 through the network interface 133. For example, the controller 170 can transmit a control signal or data to the first external equipment 510 through an accessed wired/wireless network.

The control signal or data transmission speed via the wired/wireless network of the network interface 133 is faster than the control signal or data transmission speed via the HDMI-CEC of the external device interface 135.

In the external device interface 135, control signals or data transmission using HDMI-CEC are processed as one-way communication for reception/transmission using one pin. Accordingly, when using HDMI-CEC, reception and transmission cannot be processed simultaneously. In addition, in the case of HDMI-CEC, all external equipments connected to the external device interface 135 share one CEC line. Therefore, when one external equipment connected to the external device interface 135 uses the CEC line, other external equipments connected to the external device interface 135 cannot use it until the CEC line becomes idle. For example, HDMI-CEC has a transmission speed per byte of 27.7 msec to 28.5 msec. HDMI-CEC can transmit approximately 35.7 bytes per second.

Control signals or data transmission using the network interface 133 can be transmitted simultaneously in both directions through the accessed network. The transmission speed through the network interface 133 may vary according to the network accessed environment, but if the network provides a transmission speed of 100 Mbps, approximately 12 megabytes per second can be transmitted.

The controller 170 of the display device 100 according to the embodiment can transmit a control signal or data to the first external equipment 510 through the network interface when the first external equipment 510 connected through the external device interface 135 is also connected through the network interface 133.

According to a display device and a method for driving the same according to an embodiment, when an external equipment connected to the display device is connected not only via an external device interface but also via a network interface, a control signal or data transmitted via HDMI-CEC of the external device interface can be quickly transmitted via the network interface.

According to a display device and a method for driving the same according to an embodiment, as illustrated in FIG. 12, the controller 170 of the display device 100 can detect an external equipment connected not only through the network interface 133 but also through the external device interface 135.

The display device 100 can receive a unique ID from a first external equipment connected via HDMI through an external device interface 135 (UniqueID by HDMI).

The display device 100 can request information from external equipments connected to the network through the network interface 133 (Network Search).

As an example, the description will be based on a case where a first external equipment is connected to the display device 100 via HDMI and a network, a second external equipment is connected to the display device 100 only via a network, and a third external equipment is connected to the display device 100 only via a network.

External equipments connected to the network interface 133 can respond to a request from the display device 100 by sending their own unique ID to the display device 100 (UniqueID by Network).

Alternatively, external equipments connected to the network may broadcast or multicast their own unique ID when they are detected to be connected to the network, even without a request from the display device 100.

The display device 100 can detect external equipments connected to the network interface 133 as well as the external device interface 135 by comparing the unique ID information of each external equipment received from the external equipments connected to the external device interface 135 with the unique ID information of each external equipment received from the external equipments connected to the network interface 133 (Detect Device #1 Device HDMI Connected).

The display device 100 can confirm that the first external equipment 510 is connected to the display device 100 not only via the network but also via HDMI by comparing (for example, the same ID) the unique ID (UniqueID by HBMI) of the first external equipment 510 connected via HDMI with the unique ID (UniqueID by Network) of the first external equipment 510 connected via the network.

The display device 100 can transmit network-based commands (for example, control signals or data) at high speed through the network interface 133 to an external equipment that had to transmit limited commands (for example, control signals or data) based on HDMI through the conventional external device interface 135 (Transmit Command Data using Network).

For example, the unique ID information transmitted from an external equipment connected via HDMI to the display device 100 may be provided in the form of VendorCommand (CEC_HEADER+<VendorCommandWithId>+<VendorId>+<VendorOpCode>+[UUID]) transmitted from the external equipment to the display device 100. Additionally, the unique ID information transmitted from an external equipment connected via a network to the display device 100 may be provided in the form of Network Packet (using the “MAC” Field of the HTTP Header) transmitted from the external equipment to the display device 100.

According to one embodiment of the present disclosure, the above-described method can be implemented as a processor-readable code on a medium in which a program is recorded. Examples of the processor-readable medium include a ROM, a RAM, a CD-ROM, a magnetic tape, a floppy disk, an optical data storage device, and the like.

The display device described above is not limited to the configuration and method of the embodiments described above, and the embodiments may be configured by selectively combining all or part of the embodiments so that various modifications can be made.

What is claimed is:

1. A display device comprising:
an external device interface;
a display that displays content;
a controller that receives a power-off request signal from an external equipment connected through the external device interface, and, if determining that the content displayed on the display is not content provided by the external equipment, ignores and does not process the power-off request signal received from the external equipment.

2. The display device of claim 1,
wherein the controller processes power off of the display device in response to the power off request signal received from the external equipment when determining that the content displayed on the display is content provided from the external equipment.

3. The display device of claim 1,
wherein the external device interface and the external equipment are connected using a HDMI protocol, and the power off request signal is transmitted by the HDMI-CEC (Consumer Electronics Control) power sync function of the external equipment.

4. The display device of claim 1,
wherein the external equipment connected through the external device interface includes a first external equipment and a second external equipment, and
wherein, when the content provided from the first external equipment is displayed on the display, if the power-off request signal is received from the second external equipment, the controller ignores and does not process the power-off request signal.

5. The display device of claim 4,
wherein, when the content provided from the first external equipment is displayed on the display, if the power-off request signal is received from the first external equipment, the controller processes the power-off of the display device in response to the power-off request signal.

6. The display device of claim 1,
wherein the content displayed on the display is driven as a foreground on the display.

7. The display device of claim 1,
wherein, if the content displayed on the display is displayed by a content providing application provided by the display device, the controller ignores and does not process the power off request signal.

8. The display device of claim 1,
wherein the controller determines whether to process the received control signal from the external equipment connected through the external device interface and filters and processes the received control signal according to the manufacturer of the external equipment or the type of the external equipment.

9. The display device of claim 1, further comprising:
a memory that stores an input switching request signal received from the external equipment connected through the external device interface,
wherein the controller, when the display device is turned off, if a power-on request signal and the input switching request signal are received from the external equipment, processes initialization of the display device in response to the power-on request signal, and when the initialization of the display device is completed, processes input switching to the external equipment corresponding to the input switching request signal stored in the memory.

10. The display device of claim 1, further comprising:
a network interface accessed to a network,
wherein the controller transmits a control signal or data to be transmitted to the external equipment through the network interface, if the external equipment connected through the external device interface is also connected through the network interface.

11. A method for driving a display device comprising:
receiving a power-off request signal from an external equipment connected through an external device interface;
determining whether the content displayed on the display is content provided by the external equipment; and
ignoring and not processing the power-off request signal received from the external equipment if the controller determines that the content displayed on the display is not content provided by the external equipment.

12. The method for driving a display device of claim 11,
wherein the controller processes power off of the display device in response to the power off request signal received from the external equipment when determining that the content displayed on the display is content provided from the external equipment.

13. The method for driving a display device of claim 11
wherein the external device interface and the external equipment are connected using a HDMI protocol, and the power off request signal is transmitted by the HDMI-CEC (Consumer Electronics Control) power sync function of the external equipment.

14. The method for driving a display device of claim 11,
wherein, when content provided from a first external equipment connected through the external device interface is displayed on the display, if the power off request signal is received from the second external equipment connected through the external device interface, the controller ignores and does not process the power off request signal.

15. The method for driving a display device of claim 14,
wherein, when the content provided from the first external equipment is displayed on the display, if the power-off request signal is received from the first external equipment, the controller processes the power-off of the display device in response to the power-off request signal.

16. The method for driving a display device of claim 11,
wherein the content displayed on the display is driven as a foreground on the display.

17. The method for driving a display device of claim 11,
wherein, if the content displayed on the display is displayed by a content providing application provided by the display device, the controller ignores and does not process the power off request signal.

18. The method for driving a display device of claim 11,
wherein the controller determines whether to process the received control signal from the external equipment connected through the external device interface and filters and processes the received control signal according to the manufacturer of the external equipment or the type of the external equipment.

19. The method for driving a display device of claim 11,
wherein, when the display device is turned off, if a power-on request signal and an input switching request signal are received from the external equipment, the controller stores the input switching request signal in memory while processing the initialization of the display device in response to the power-on request signal, and
wherein, when the initialization of the display device is completed, the controller processes the input switching to the external equipment corresponding to the input switching request signal stored in the memory.

20. The method for driving a display device of claim 11,
wherein, if the external equipment connected through the external device interface is also connected through a network interface that is accessed to a network, the controller transmits a control signal or data to be transmitted to the external equipment through the network interface.
